(19) United States
(12) Patent Application Publication
(10) Pub. No.: US 2015/0358972 A1
(43) Pub. Date: Dec. 10, 2015

(54) METHOD AND APPARATUS FOR TRANSMITTING CELL LOAD INFORMATION IN WIRELESS COMMUNICATION SYSTEM

(71) Applicant: LG ELECTRONICS INC., Yeongdeungpo-gu, Seoul (KR)

(72) Inventors: Insun LEE, Seoul (KR); Daewook BYUN, Seoul (KR); Jian XU, Seoul (KR); Kyungmin PARK, Seoul (KR)

(73) Assignee: LG ELECTRONICS INC., Seoul (KR)

(21) Appl. No.: 14/760,531

(22) PCT Filed: Jan. 23, 2014
(86) PCT No.: PCT/KR2014/000642

§ 371 Date: Jul. 13, 2015

Related U.S. Application Data
(60) Provisional application No. 61/773,792, filed on Mar. 6, 2013.
(60) Provisional application No. 61/755,474, filed on Jan. 23, 2013.

(51) Int. Cl. H04W 72/04

(52) U.S. Cl. CPC H04W 72/0486

(57) ABSTRACT

A method and apparatus for transmitting cell load information in a wireless communication system is provided. According to an embodiment of the present invention, an eNodeB (eNB) of 3rd generation partnership project (3GPP) long-term evolution (LTE) system and a radio network controller (RNC) of universal mobile telecommunications system (UMTS) transmit cell load information via a direct path between the eNB and the RNC. According to another embodiment of the present invention, the eNB and the RNC transmit cell load information through S1 gateway.

### BACKGROUND OF THE INVENTION

1. Field of the Invention

The present invention relates to wireless communications, and more particularly, to a method and apparatus for transmitting cell load information in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an Si interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 2, the RLC and MAC layers (terminated in the eNB on the network side) may perform functions such as scheduling, automatic repeat request (ARQ), and hybrid automatic repeat request (HARQ). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULlnterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value In the UL in the signature.

Long-term coexistence is likely to occur between UMTS/high speed packet access (HSPA) and LTE in one operator's network which places interworking mechanism into a very important position. Currently inter-radio access technology (RAT) handover between UMTS/HSPA and LTE uses relocation procedures. Several small evolutions have been done to make these procedure work better from LTE Rel-8.

However, extensive handover messages and excessive signaling loads in current UMTS/HSPA and LTE interworking may lead to low network efficiency and suboptimal user experience in practical deployments. Such problems could be even more critical in LTE initial deployments (limited LTE coverage) or hotspot type of deployments, leading to frequent inter-RAT handovers and other interoperation procedures.

In order to facilitate multi-RAT deployment and operation, there is a strong need to investigate possible mechanism for seamless UMTS/HSPA and LTE interworking. Besides the enhancement of existing mechanisms, interoperation between two RATs handled by a radio access network (RAN) would be a promising approach in order to benefit mobility performance and reduce impact and resource burden on a core network. Possible performance benefits from RAN level interworking needs to be balanced against the additional impact on network, with reasonable cost guaranteed.

As the LTE systems are deployed for serving explosive data traffic of mobile communications, it is expected that the LTE system are deployed so that small eNBs having a low power cover hotspots. A method for reducing signaling overhead for multiple small eNBs of the LTE system may be required.

### SUMMARY OF THE INVENTION

The present invention provides a method and apparatus for transmitting cell load information in a wireless communication system. The present invention provides interworking architecture for reducing signaling overhead of a core network when a universal mobile telecommunications system (UMTS) macro cell and long-term evolution (LTE) small cells, which cover hotspot area, coexist. The present invention provides architecture using an S1 gateway when LTE small cells are deployed densely, and provides an intra-LTE load balancing method using the architecture.

In an aspect, a method for transmitting, by an eNodeB (eNB) of a first system, cell load information in a wireless communication system is provided. The method includes transmitting cell load information of a cell, managed by the eNB, to a radio network controller (RNC) of a second system via a direct path between the eNB and the RNC.

The cell load information may be transmitted in a periodic manner or an event-triggered manner.

The cell load information may be transmitted after receiving a request for the cell load information from the RNC of the second system via the direct path.

The cell load information may include cell load information of cells managed by a plurality of eNBs in a cluster, where the plurality of eNBs are deployed densely.

The cell load information of cells managed by the plurality of eNBs may be received in a periodic manner or an event-triggered manner.

The cell load information of cells managed by the plurality of eNBs may be received via a resource status response message or a resource status update message.

In another aspect, a method for transmitting, by a radio network controller (RNC) of a second system, cell load information in a wireless communication system is provided. The method includes transmitting cell load information of a cell, managed by the RNC, to an eNodeB (eNB) of a first system via a direct path between the eNB and the RNC.

The cell load information may be transmitted after receiving a request for the cell load information from the eNB of the first system via the direct path.

The cell load information may be transmitted to the eNB of the first system through a cluster head which is a representative eNB of a cluster where a plurality of eNBs are deployed densely.

In another aspect, a method for transmitting, by a S1 gateway (GW), cell load information in a wireless communication system is provided. The method includes receiving cell load information of a cell, managed by a radio network controller (RNC) of the second system, from the RNC, and transmitting the received cell load information to a plurality of eNodeBs (eNBs) of the first system, respectively.

The cell load information may be received using a mobility management entity (MME) direct information transfer message via an S1 interface, and wherein the cell load information may be received from the RNC via an MME and a serving GPRS support node (SGSN).

The received cell load information may be transmitted using an MME direct information transfer message.

The method may further include receiving cell load information requests from the plurality of eNBs of the first system.

Network loads for obtaining cell information between heterogeneous systems can be reduced when LTE small cells are deployed in a UMTS macro cell. In addition, loads of S1 interface and core network can be reduced by using an S1 gateway when LTE small cells are deployed as a form of a cluster. Accordingly, LTE small cells can be used efficiently.

### BRIEF DESCRIPTION OF THE DRAWINGS

FIG. 1 shows LTE system architecture.

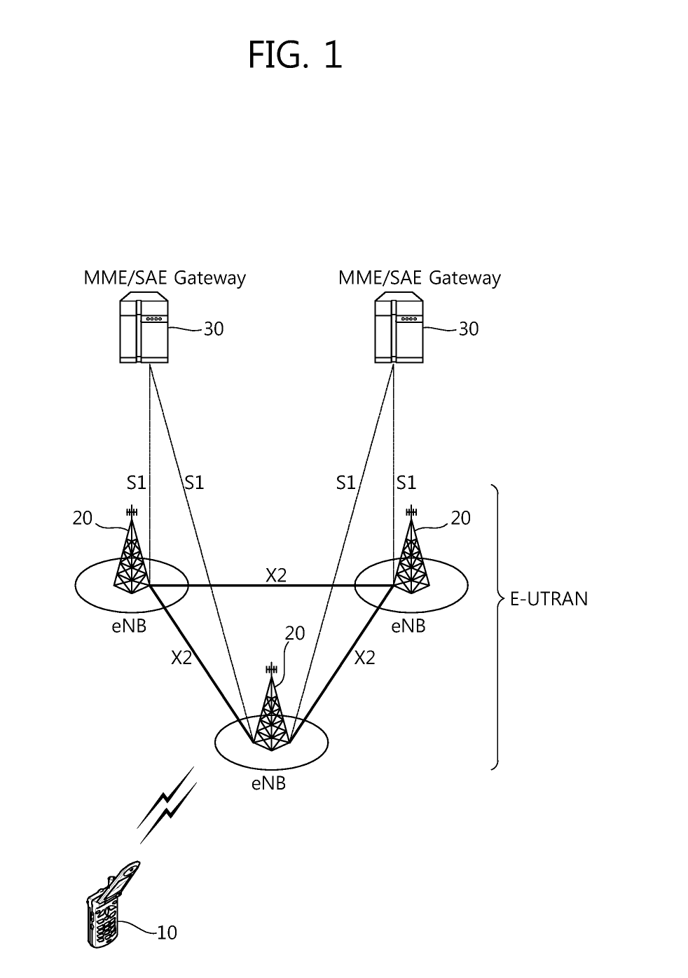

FIG. 2 shows a control plane of a radio interface protocol of an LTE system.

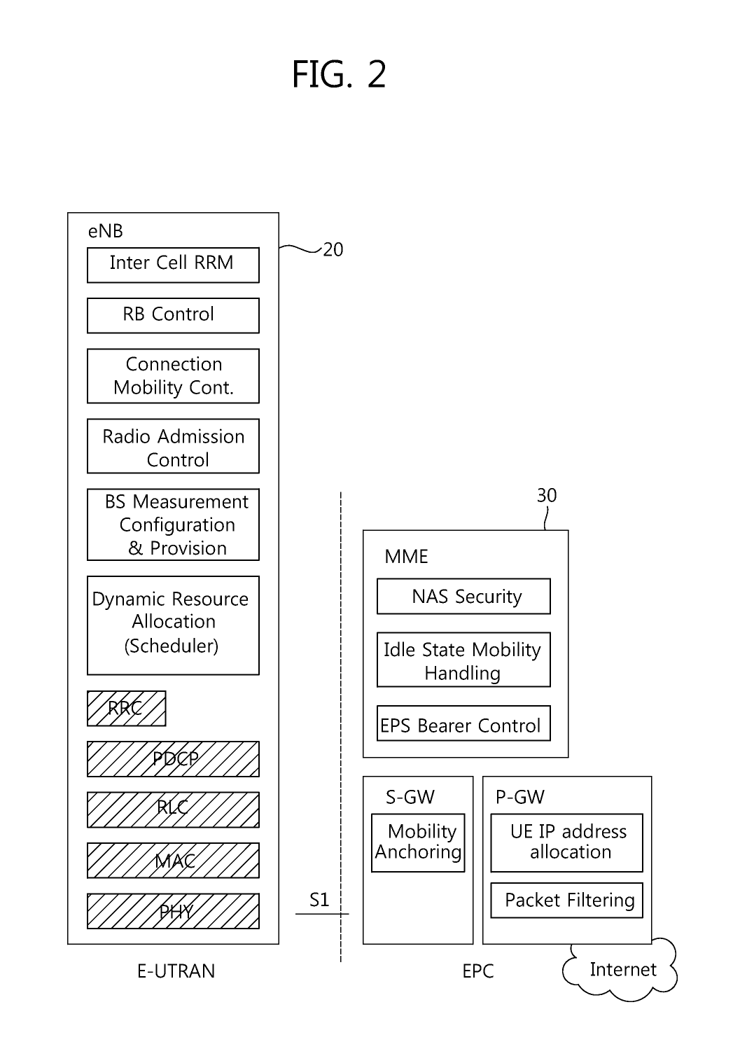

FIG. 3 shows a user plane of a radio interface protocol of an LTE system.

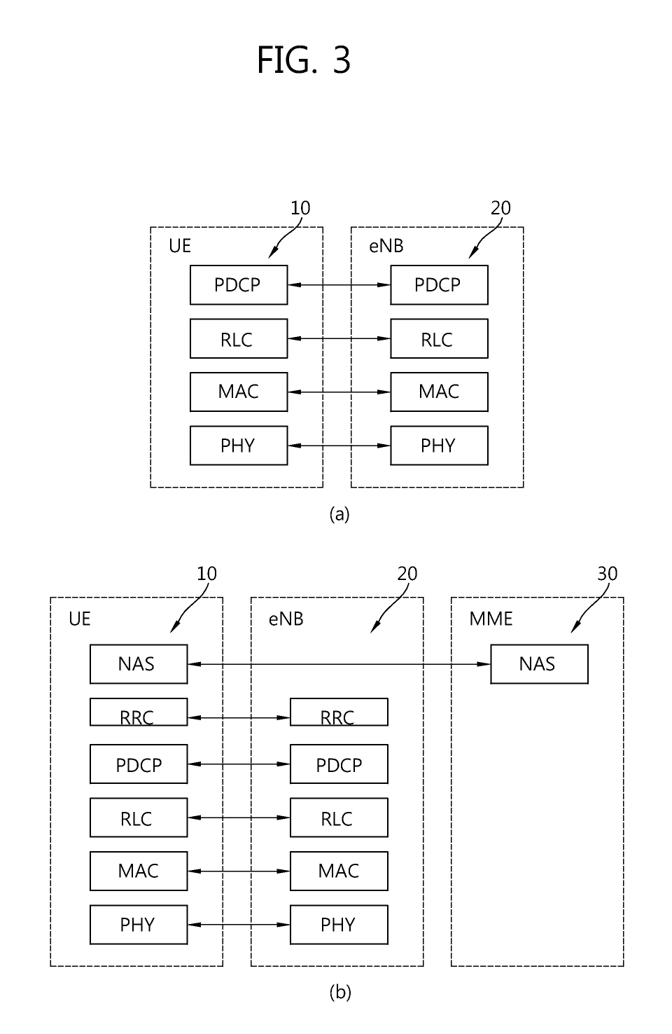

FIG. 4 shows an example of a physical channel structure.

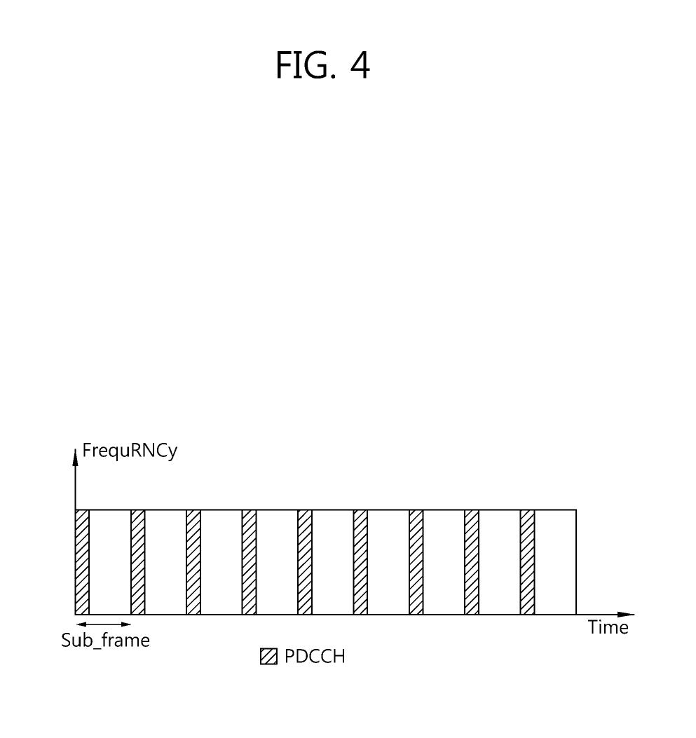

FIG. 5 shows an example of hotspot deployment of LTE small cells with a UMTS macro cell.

FIG. 6 shows an example of a current inter-RAT RIM procedure.

FIG. 7 shows an example of singling overhead according to a current inter-RAT RIM procedure.

FIG. 8 shows an example of hotspot deployment of LTE small cells with a UMTS macro cell according to an embodiment of the present invention.

FIG. 9 shows an example of a method for transmitting cell load information according to an embodiment of the present invention.

FIG. 10 shows an example of a method for transmitting cell load information according to another embodiment of the present invention.

FIG. 11 shows an example of a method for transmitting cell load information according to another embodiment of the present invention.

FIG. 12 shows an example of a method for transmitting cell load information according to another embodiment of the present invention.

FIG. 13 shows an example of a method for transmitting cell load information using a cluster head according to an embodiment of the present invention.

FIG. 14 shows an example of a method for transmitting cell load information using a cluster head according to an embodiment of the present invention.

FIG. 15 shows an example of a method for transmitting cell load information using a cluster head according to another embodiment of the present invention.

FIG. 16 shows an example of a method for transmitting cell load information using a cluster head according to another embodiment of the present invention.

FIG. 17 shows an example of a method for transmitting cell load information using a cluster head according to another embodiment of the present invention.

FIG. 18 shows an example of a method for transmitting cell load information using a cluster head according to another embodiment of the present invention.

FIG. 19 shows an example of a method for transmitting cell load information using a cluster head according to another embodiment of the present invention.

FIG. 20 shows an example of small cell architecture including an S1 GW according to an embodiment of the present invention.

FIG. 21 shows an example of small cell architecture including an S1 GW according to another embodiment of the present invention.

FIG. 22 shows an example of small cell architecture including an S1 GW according to another embodiment of the present invention.

FIG. 23 shows an example of method for transmitting cell load information using an S1 GW according to an embodiment of the present invention.

FIG. 24 shows an example of method for transmitting cell load information using an S1 GW according to another embodiment of the present invention.

FIG. 25 shows an example of method for transmitting cell load information using an S1 GW according to another embodiment of the present invention.

FIG. 26 shows an example of method for transmitting cell load information using an S1 GW according to another embodiment of the present invention.

FIG. 27 shows an example of method for transmitting cell load information using an S1 GW according to another embodiment of the present invention.

FIG. 28 shows an example of method for transmitting cell load information using an S1 GW according to another embodiment of the present invention.

FIG. 29 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

On top of the existing macro UMTS system deployment, the LTE system may tend to be deployed as a form of small cells such as pico cells in hotspot areas as an initial type of deployment. By deploying the small cells in a hotspot area, supporting higher capacity for the heterogeneous traffic demand for certain area may result in better performance for users.

The types of hotspots may vary according to density of the small cells or where the hotspot area is located. From the perspective of density for hotspot coverage, the small cells can be deployed densely or sparsely. Also the hotspot area can be formed in outdoor areas such as train stations or busy urban areas, or indoor areas such as, airports, shopping malls, and office buildings.

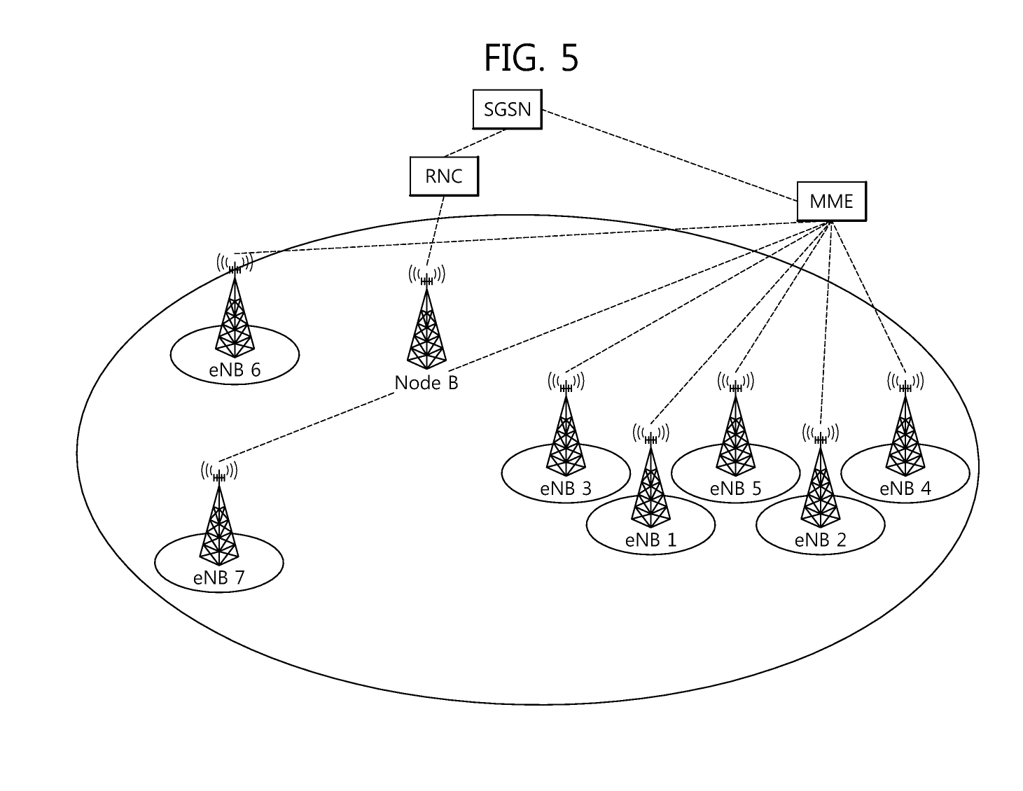

FIG. 5 shows an example of hotspot deployment of LTE small cells with a UMTS macro cell.

Referring to FIG. 5, a UMTS Node B provides a UMTS macro cell. The Node B is connected with a radio network controller (RNC). Each of eNodeB (eNB)1 to eNB7 provides hotspot LTE small cells, respectively. eNB1 to eNBS are deployed densely in a hotspot area. eNB6 and eNB7 are deployed sparsely in a hotspot area. Each eNB is connected with a mobility management entity (MME). The MME and the RNC is connected via a serving GPRS support node (SGSN).

One of the major purposes of hotspot deployment is to boosting up the capacity for the corresponding areas. The indoor data offloading reduces interference with outdoor macro cells, and it can also provide reduction in battery consumption. However, for efficient use of available spectrum, traffic data steering considering load information of macro and pico cells needs to be considered. In the example described in FIG. 5, load balancing between the UMTS macro cell and the hotspot LTE small cells is to be considered for efficient use of overlay networks.

Currently, load balancing for inter-radio access technology (RAT) can be provided using radio access network (RAN) information management (RIM) function for inter-RAT in a self-optimization network (SON). In this procedure, load information is transferred between RAN nodes via a core network.

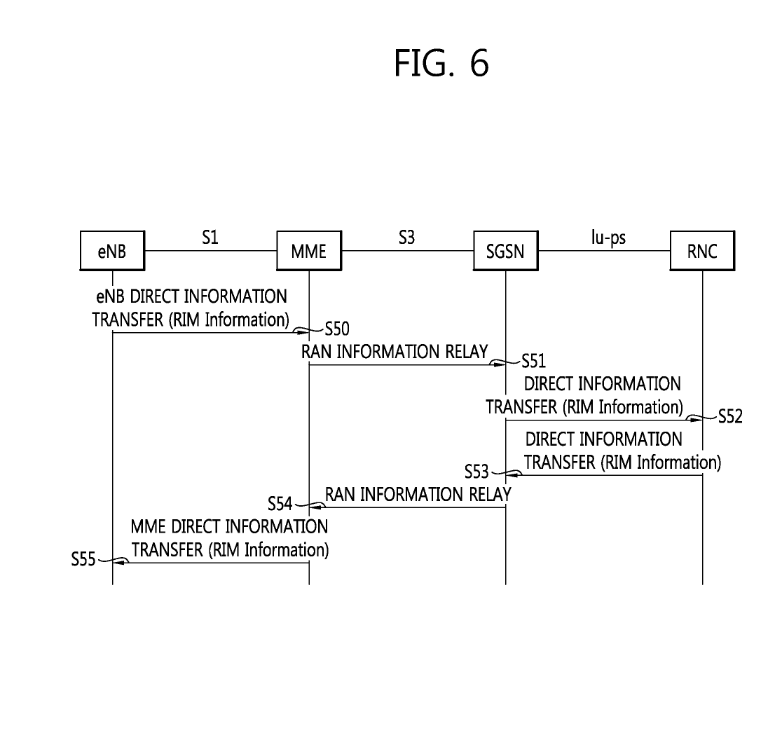

FIG. 6 shows an example of a current inter-RAT RIM procedure.

In step S50, an eNB transmits an eNB direct information transfer message including RIM information to an MME via the S1 interface. In step S51, the MME transmits an RAN information relay message including the RIM information to an SGSN via the S3 interface. In step S52, the SGSN transmits a direct information transfer message including the RIM information to an RNC via Iu-ps interface. In step S53, the RNC transmits a direct information transfer message including the RIM information to the SGSN via Iu-ps interface. In step S54, the SGSN transmits an RAN information relay message including the RIM information to the MME via the S3 interface. In step S55, the MME transmits an MME direct information transfer message including the RIM information to the eNB via the S1 interface.

However, when the LTE small cells are deployed densely in hotspot areas, heavy signaling overhead may be caused with the current RIM procedure. For example, referring to FIG. 5 described above, it is assumed that eNB1, eNB2 and eNB3, among eNB1 to eNBS deployed in a hotspot area, request load information to the RNC. In this case, each eNB transmits the eNB direct information transfer message to the MME, and therefore, heavy signaling overhead may occur.

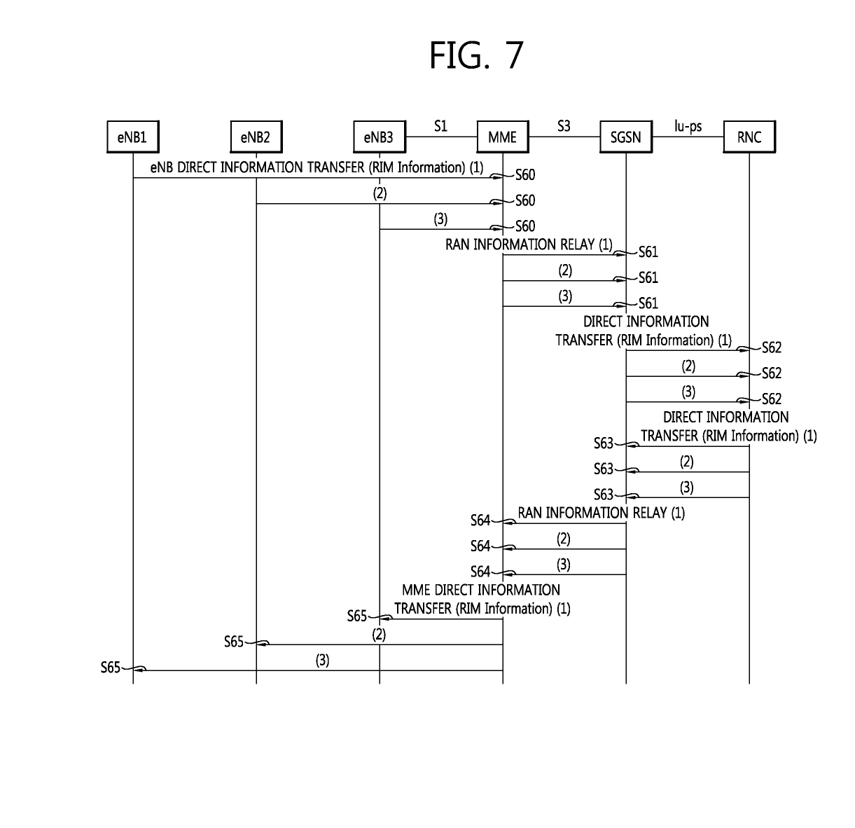

FIG. 7 shows an example of singling overhead according to a current inter-RAT RIM procedure.

Referring to FIG. 7, in step S60, eNB1, eNB2, and eNB3 transmit eNB direct information transfer messages including RIM information to the MME via the S1 interface, respectively. In step S61, the MME transmits RAN information relay messages including the RIM information, for the eNB1, eN2, and eNB3, to the SGSN via the S3 interface. In step S62, the SGSN transmits direct information transfer messages including the RIM information, for the eNB1, eN2, and eNB3, to the RNC via Iu-ps interface. In step S63, the RNC transmits direct information transfer messages including the RIM information, for the eNB1, eN2, and eNB3, to the SGSN via Iu-ps interface. In step S64, the SGSN transmits RAN information relay messages including the RIM information, for the eNB1, eN2, and eNB3, to the MME via the S3 interface. In step S65, the MME transmits MME direct information transfer messages including the RIM information to the eNB1, eN2, and eNB3 via the S1 interface, respectively.

As describe above, as the number of eNBs increases, signaling overhead increases linearly. Signaling overhead can cause overload on a network.

Hereinafter, a method for transmitting information in a RAN without using a core network is described when the UMTS and LTE are interworked. The information may include load information and various types of information for interworking of the UMTS and LTE.

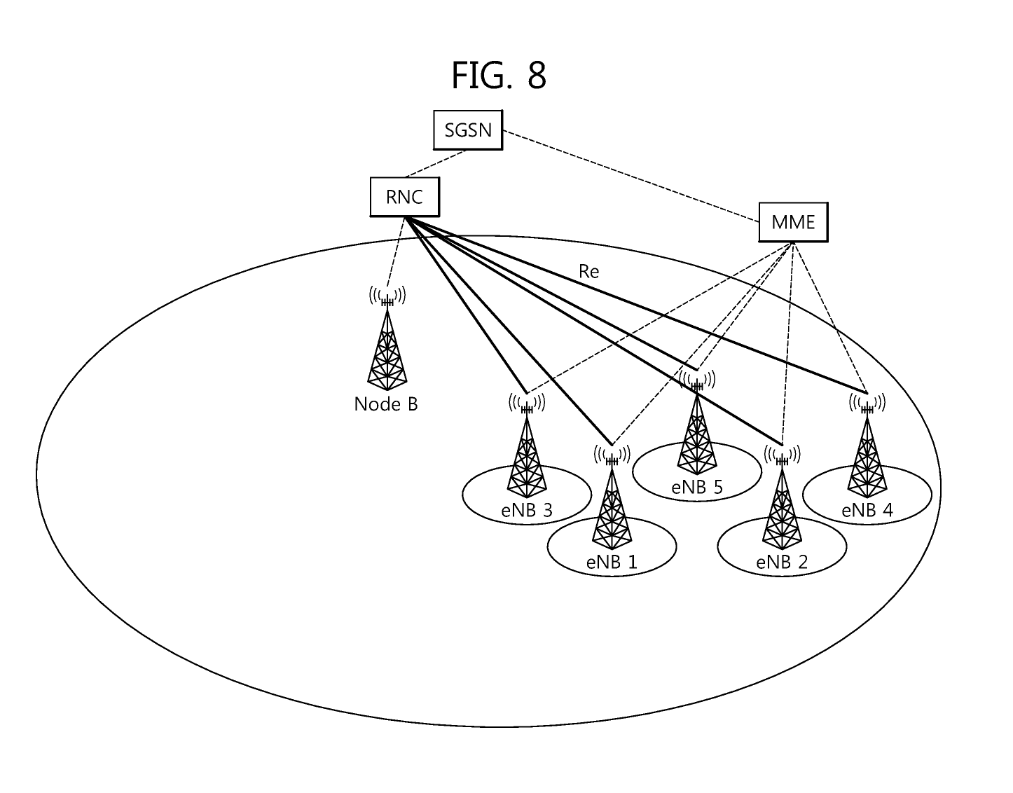

FIG. 8 shows an example of hotspot deployment of LTE small cells with a UMTS macro cell according to an embodiment of the present invention.

Referring to FIG. 8, each of eNB1 to eNB5 provides hotspot LTE small cells, respectively. Each of eNB1 to eNB5 is connected with the RNC via a direct path. That is, a direct path between each LTE small cell eNB and RNC is defined. Hereinafter, the direct path is called “Re path”. The Re path may exist between the RNC and each of all LTE small cell eNBs which cover hotspot. Or, LTE small cell eNBs, which are densely deployed, is regarded as one cluster, and the Re path may exist between the RNC and a representative eNB of the cluster. In this case, the representative eNB may be called a head eNB or a cluster head (CH).

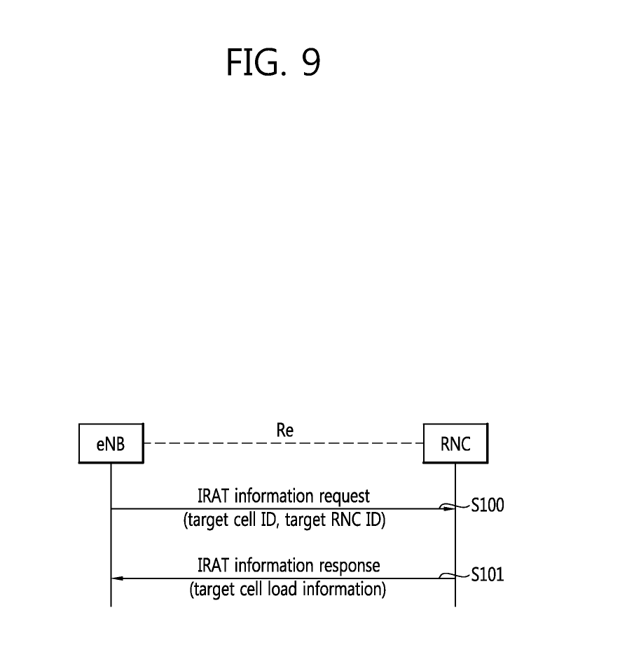

FIG. 9 shows an example of a method for transmitting cell load information according to an embodiment of the present invention. In this embodiment, the LTE small cell eNB requests cell load information from the RNC.

Referring to FIG. 9, in step S100, the eNB transmits an inter-RAT (IRAT) information request message to the RNC via the Re path. Accordingly, the eNB may request target cell load information from the RNC via the Re path. The IRAT information request message may include a target cell identifier (ID) and target RNC ID. In step s101, the RNC transmits an IRAT information response message, including the requested target cell load information, to the eNB via the Re path. It is assumed that the RNC knows load information of cells managed by the RNC.

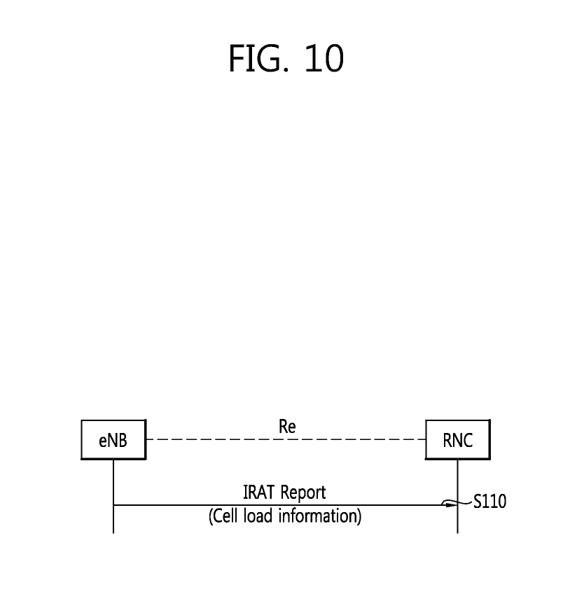

FIG. 10 shows an example of a method for transmitting cell load information according to another embodiment of the present invention. In this embodiment, the LTE small cell eNB reports cell load information of the LTE small cell to the RNC.

Referring to FIG. 10, in step S110, the eNB transmits an IRAT report message, including the cell load information of the LTE small cell, to the RNC via the Re path. The cell load information of the LTE small cell may be included in the IRAT report message as a form of an information element (IE). The cell load information of the LTE small cell may be reported in a periodic manner. Alternatively, the cell load information of the LTE small cell may be reported in an event-triggered manner. In the event-triggered manner, the eNB may report the cell load information when load exceeds a threshold. The threshold may be pre-determined by load levels of the LTE small cell. That is, the eNB may report the cell load information when load exceeds each load level of the LTE small cell. For example, it is assumed that load levels of the LTE small cell is determined as 3-steps, and the eNB may report the cell load information when the load of the LTE small cell exceeds each load level of the LTE small cell.

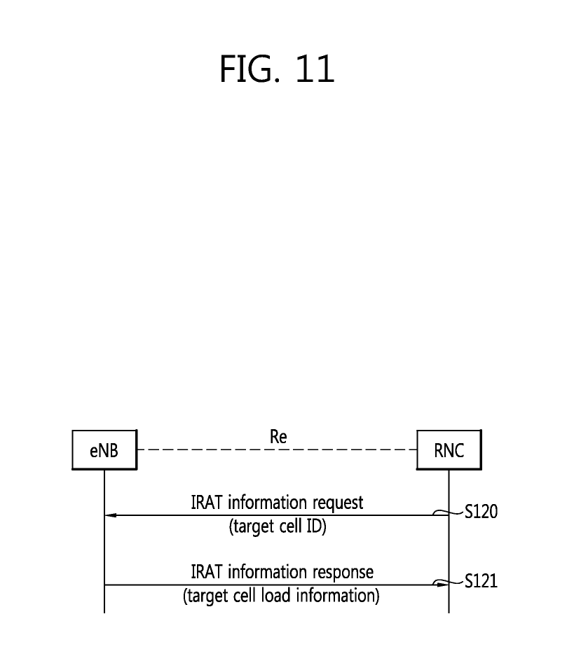

FIG. 11 shows an example of a method for transmitting cell load information according to another embodiment of the present invention. In this embodiment, the RNC requests cell load information from the LTE small cell eNB.

Referring to FIG. 11, in step S120, the RNC transmits an IRAT information request message to the eNB via the Re path. Accordingly, the RNC may request target cell load information from the eNB via the Re path. The IRAT information request message may include a target cell ID. In step s121, the eNB transmits an IRAT information response message, including the requested target cell load information, to the RNC via the Re path.

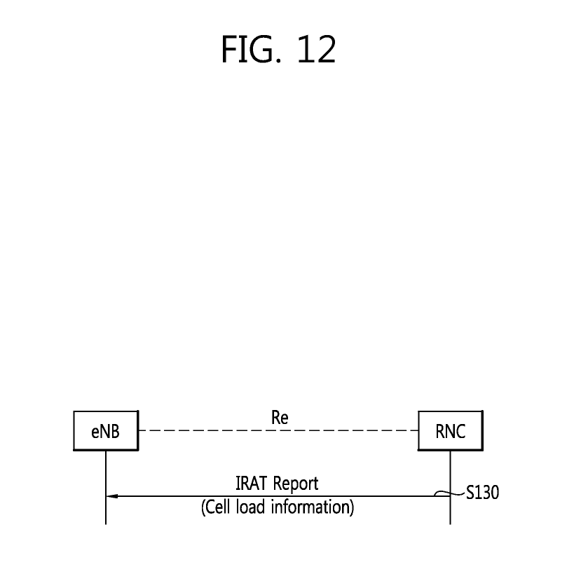

FIG. 12 shows an example of a method for transmitting cell load information according to another embodiment of the present invention. In this embodiment, the RNC reports cell load information of cells managed by itself to the LTE small cell eNB.

Referring to FIG. 12, in step S130, the RNC transmits an IRAT report message, including the cell load information of cells managed by the RNC, to the eNB via the Re path. The cell load information of the cells managed by the RNC may be reported in a periodic manner or an event-triggered manner.

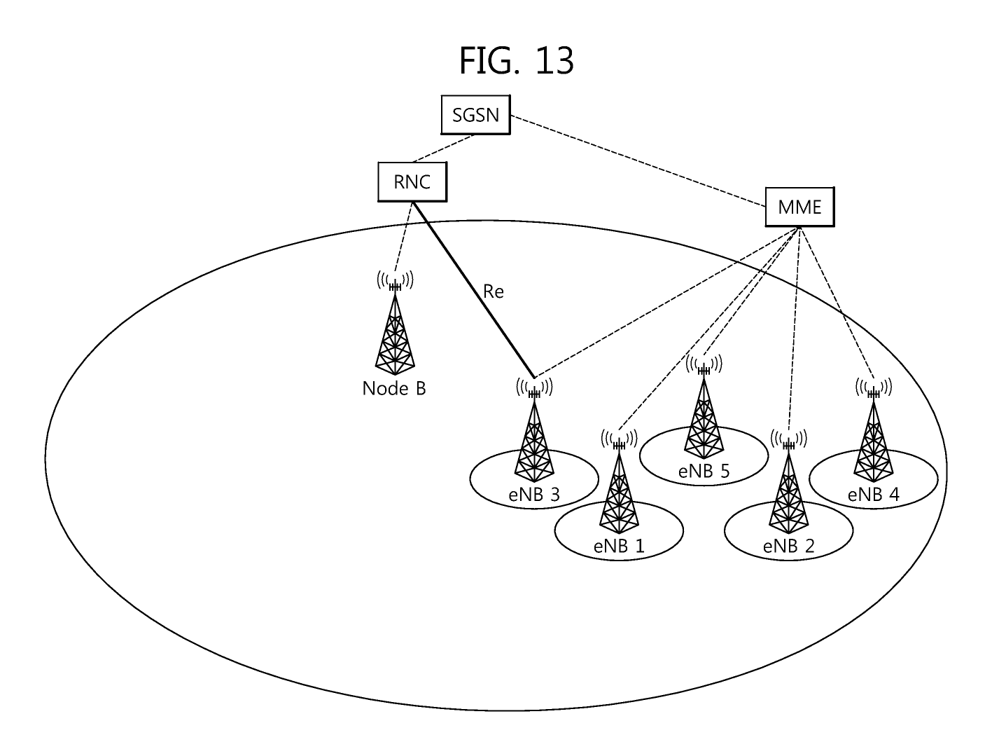

FIG. 13 shows an example of a method for transmitting cell load information using a cluster head according to an embodiment of the present invention.

Referring to FIG. 13, each of eNB1 to eNB5 provides hotspot LTE small cells, respectively, and the eNB1 to eNB5 form one cluster. One eNB among small cell eNBs may be configured as a cluster head (CH). In FIG. 13, eNB3, from eNB1 to eNB5, is configured as the CH. The CH may be pre-configured when deployed. The CH is connected with the RNC via the direct Re path. In addition, it is assumed that the CH is connected with other eNBs via the X2 interface.

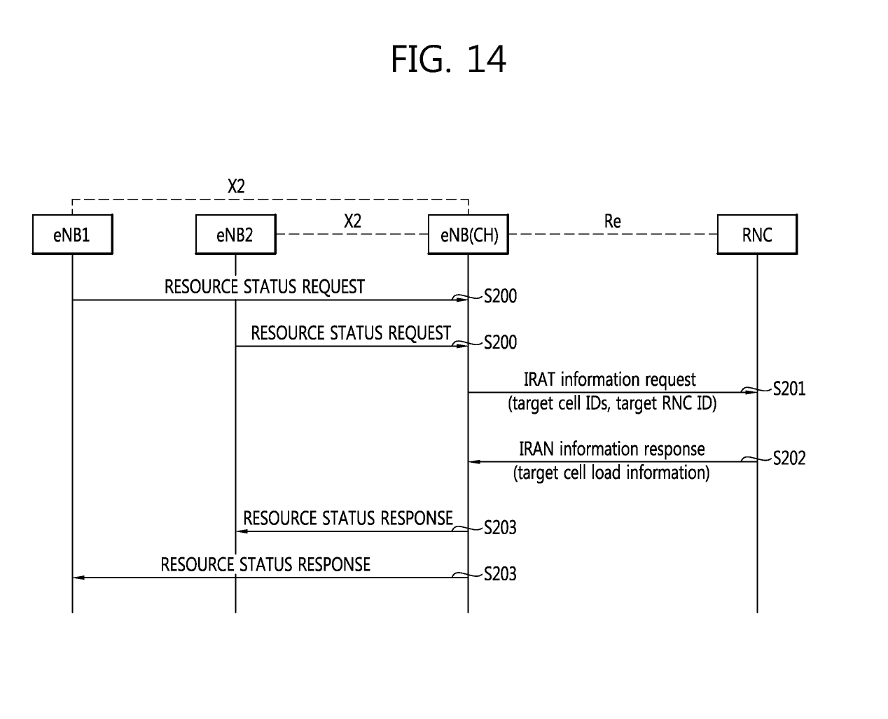

FIG. 14 shows an example of a method for transmitting cell load information using a cluster head according to an embodiment of the present invention. In this embodiment, the CH requests cell load information of the UMTS target cell.

Referring to FIG. 14, in step S200, the eNB1 and eNB2, located in a cluster of LTE small cells, transmit resource status request messages to the CH via the X2 interface, respectively. The resource status request message may include a request for target cell load information. The request for the target cell load information may be included in the resource status request message as a form of an “IRAT target cell ID IE”. The resource status request message is previously defined in the X2 interface. Alternatively, the eNB1 and eNB2 may transmit newly defined messages for requesting the target cell load information to the CH.

In step S201, upon receiving the resource status request messages requesting the target cell load information, the CH transmits an IRAT information request message to the RNC via the Re path. Accordingly, the CH may request target cell load information from the RNC via the Re path. The IRAT information request message may include target cell IDs and target RNC ID. In step s202, the RNC transmits an IRAT information response message, including the requested target cell load information, to the CH via the Re path.

In step S203, the CH transmits resource status response messages to the eNB1 and eNB2, respectively, via the X2 interface. The resource status response message may include the IRAT target cell ID IE and the requested target cell load information. Or, instead of the resource status response message, the resource status update message may be transmitted via the X2 interface for this purpose.

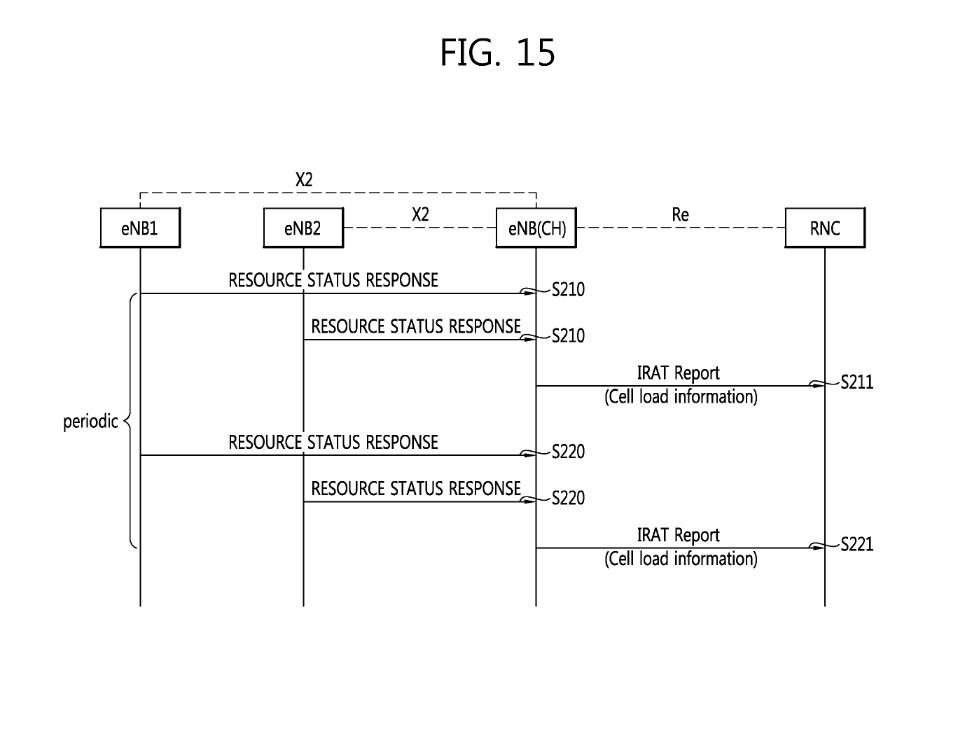

FIG. 15 shows an example of a method for transmitting cell load information using a cluster head according to another embodiment of the present invention. In this embodiment, the CH reports cell load information of small cells in a cluster to the RNC in a periodic manner.

Referring to FIG. 15, in step S210, the eNB1 and eNB2, located in a cluster of LTE small cells, transmit resource status response messages to the CH via the X2 interface, respectively. The resource status response message includes cell load information of each LTE small cell in the cluster. Or, instead of the resource status response message, the resource status update message may be transmitted via the X2 interface for this purpose.

In step S211, the CH transmits an IRAT report message, including the cell load information of the LTE small cells in the cluster, to the RNC via the Re path. The cell load information of the LTE small cells in the cluster may be included in the IRAT report message as a form of a cell load information IE. The IRAT report message may include a plurality of cell load information IEs for the LTE small cells in the cluster.

In step S220, in a next period, the eNB1 and eNB2 transmit again the resource status response messages to the CH via the X2 interface, respectively. The resource status response message includes cell load information of each LTE small cell in the cluster. In step S221, the CH transmits the IRAT report message, including the cell load information of the LTE small cells in the cluster, to the RNC via the Re path.

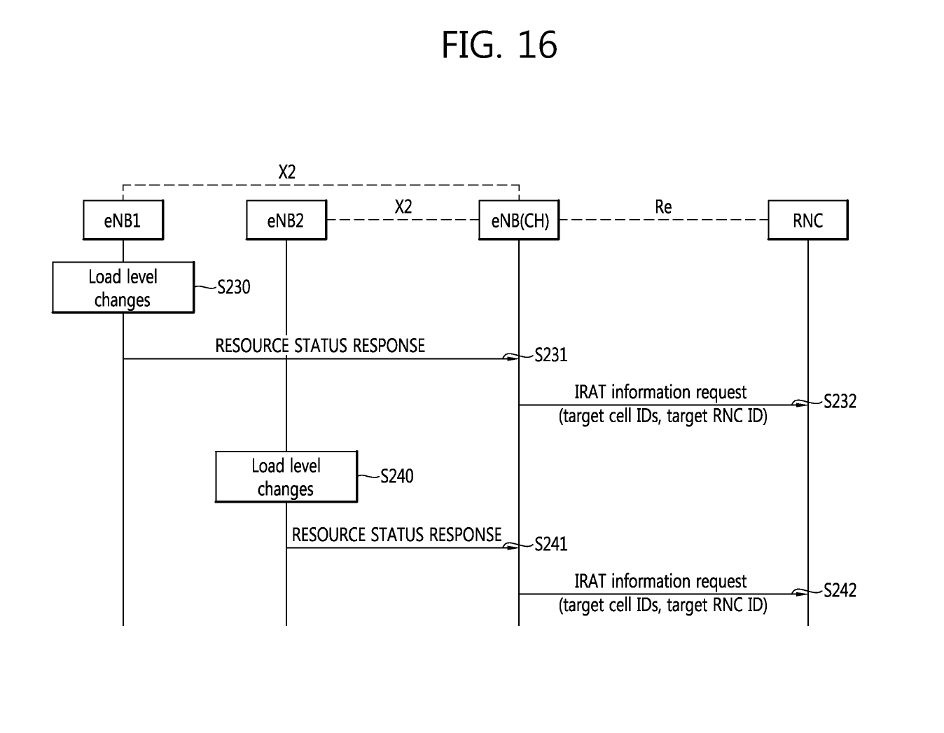

FIG. 16 shows an example of a method for transmitting cell load information using a cluster head according to another embodiment of the present invention. In this embodiment, the CH reports cell load information of small cells in a cluster to the RNC in an event-triggered manner.

In the event-triggered manner, the CH may report the cell load information of LTE small cells in the cluster when load of a LTE small cell served by a specific eNB exceeds a threshold. The threshold may be pre-determined by load levels of the LTE small cell. That is, the specific eNB may report the cell load information of the LTE small cell served by itself to the CH when load exceeds each load level of the LTE small cell, and the CH delivers the reported cell load information to the RNC. For example, it is assumed that load levels of the LTE small cell served by the specific eNB is determined as 3-steps, and the specific eNB may report the cell load information to the CH when the load of the LTE small cell exceeds each load level of the LTE small cell.

Referring to FIG. 16, in step S230, load level of a LTE small cell served by the eNB1 changes. Accordingly, in step S231, the eNB1 transmits a resource status response message to the CH. The resource status response message includes cell load information of the LTE small cell served by the eNB1. Or, instead of the resource status response message, the resource status update message may be transmitted via the X2 interface for this purpose.

In step S232, the CH transmits an IRAT report message, including the cell load information of the LTE small cell served by the eNB 1, to the RNC via the Re path. The cell load information of the LTE small cell served by the eNB1 may be included in the IRAT report message as a form of a cell load information IE.

In step S240, load level of a LTE small cell served by the eNB2 changes. Accordingly, in step S241, the eNB2 transmits a resource status response message to the CH. The resource status response message includes cell load information of the LTE small cell served by the eNB2. Or, instead of the resource status response message, the resource status update message may be transmitted via the X2 interface for this purpose.

In step S242, the CH transmits an IRAT report message, including the cell load information of the LTE small cell served by the eNB2, to the RNC via the Re path. The cell load information of the LTE small cell served by the eNB2 may be included in the IRAT report message as a form of a cell load information IE.

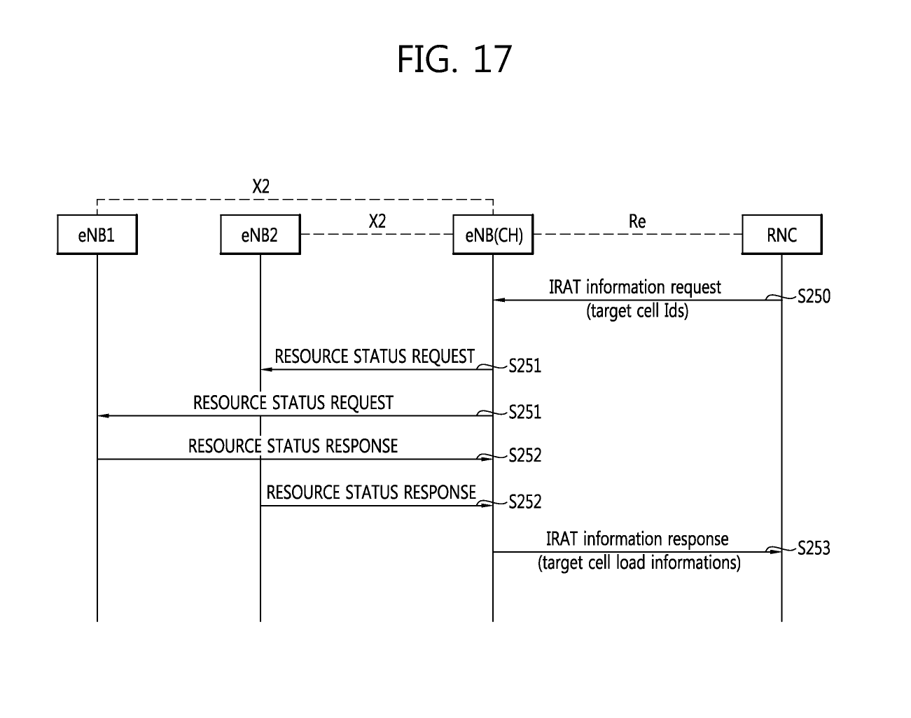

FIG. 17 shows an example of a method for transmitting cell load information using a cluster head according to another embodiment of the present invention. In this embodiment, the RNC requests target cell load information from the CH.

Referring to FIG. 17, in step S250, the RNC transmits an IRAT information request message to the CH via the Re path. Accordingly, the RNC may request target cell load information from the CH via the Re path. The IRAT information request message may include target cell IDs.

In step S251, the CH transmits resource status request messages to the eNB1 and eNB2, respectively, for requesting the target cell load information. In step S252, the eNB1 and eNB2 transmits resource status response messages to the CH, respectively. The resource status response message includes cell load information of each target cell.

In step S253, the CH transmits an IRAT information response message, including the requested target cell load information, to the RNC via the Re path. If the CH knows recent target cell load information of LTE small cells in the cluster, the step S251 and S252 may be omitted, and accordingly, the CH may transmit the IRAT information response message immediately upon receiving the IRAT information request message.

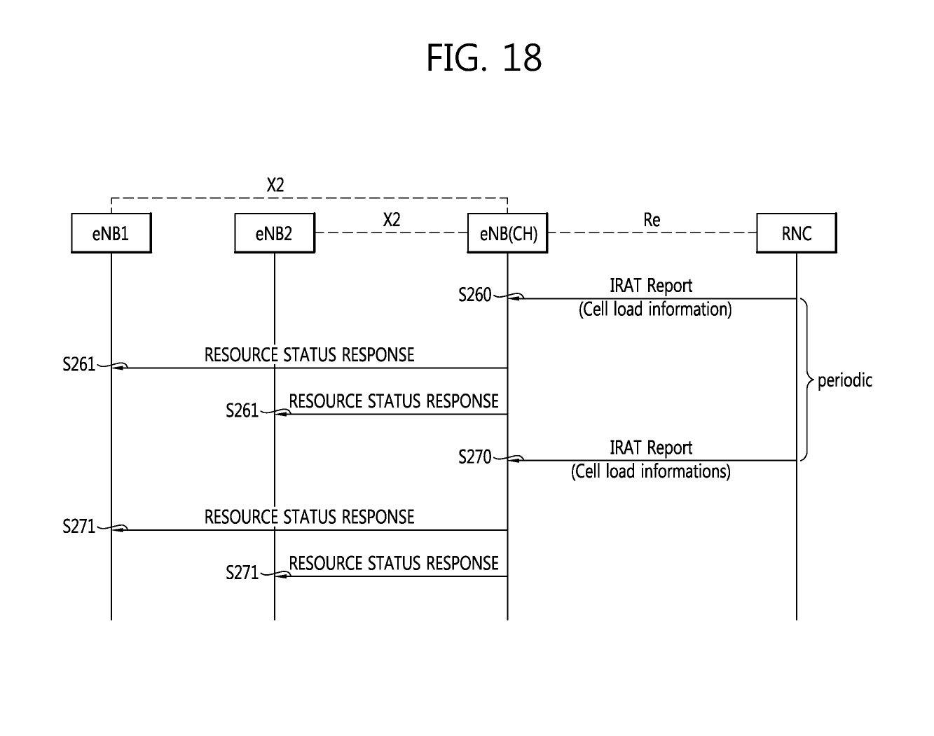

FIG. 18 shows an example of a method for transmitting cell load information using a cluster head according to another embodiment of the present invention. In this embodiment, the RNC reports cell load information of cells managed by itself to the LTE small cell eNB in a periodic manner.

Referring to FIG. 18, in step S260, the RNC transmits an IRAT report message, including the cell load information of cells managed by the RNC, to the CH via the Re path. In step S261, the CH transmits resource status response messages, including the cell load information of cells managed by the RNC, to the eNB1 and eNB2, respectively.

In step S270, in a next period, the RNC transmits again the IRAT report message, including the cell load information of cells managed by the RNC, to the CH via the Re path. In step S271, the CH transmits resource status response messages, including the cell load information of cells managed by the RNC, to the eNB1 and eNB2, respectively.

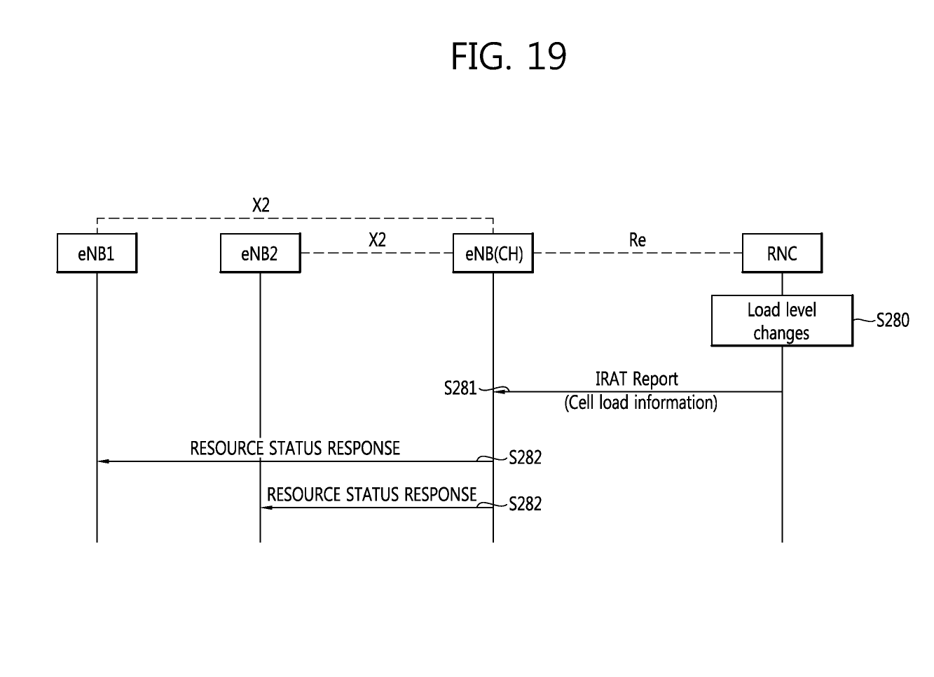

FIG. 19 shows an example of a method for transmitting cell load information using a cluster head according to another embodiment of the present invention. In this embodiment, the RNC reports cell load information of cells managed by itself to the LTE small cell eNB in an event-triggered manner.

Referring to FIG. 19, in step S280, load level of cells managed by the RNC changes. Accordingly, in step S281, the RNC transmits an IRAT report message, including the cell load information managed by the RNC, to the CH. In step S282, the CH transmits resource status response messages, including the cell load information of cells managed by the RNC, to the eNB1 and eNB2, respectively.

Hereinafter, when the UMTS and LTE are interworked, a new interworking architecture of LTE small cells is described. The new interworking architecture of LTE small cells uses a newly deployed S1 gateway (GW). The S1 GW may be deployed for hotspots which boost up capacity within coverage of a UMTS macro cell or LTE macro cell. Or, the S1 GW may be deployed for expansion of coverage of the UMTS macro cell or LTE macro cell. In addition, when LTE small cells are deployed densely in coverage of a LTE macro cell, a method for reducing signaling overhead of a core network is described.

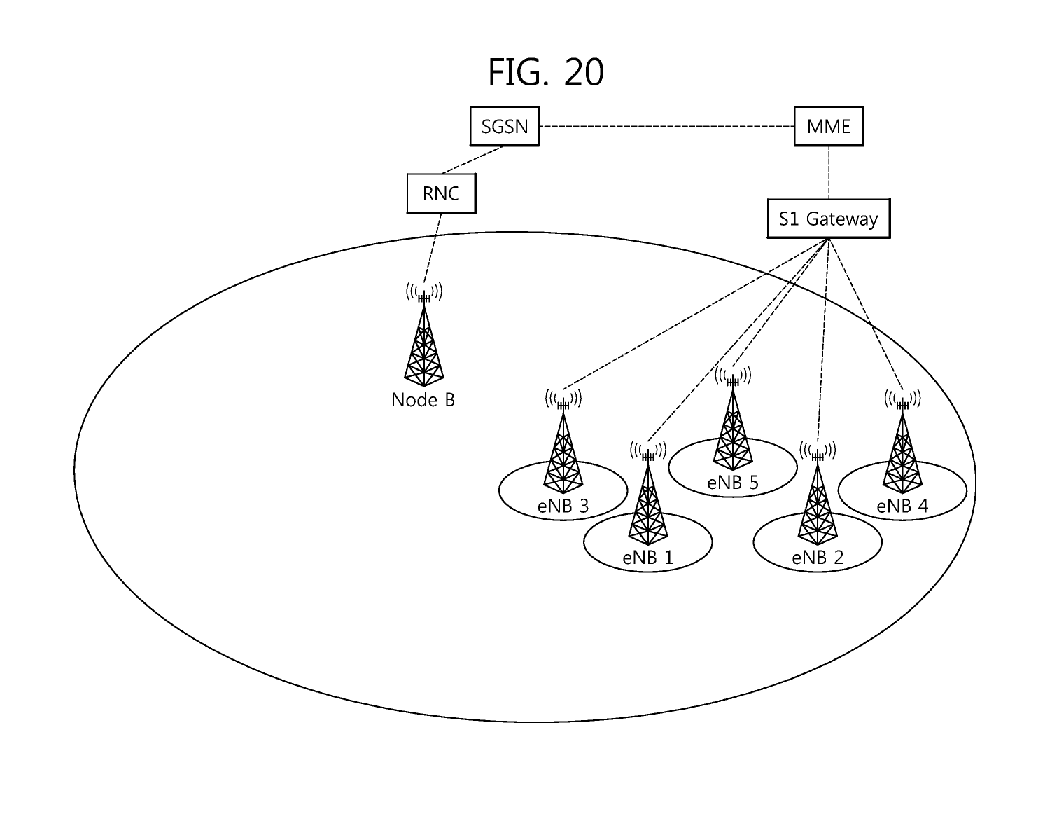

FIG. 20 shows an example of small cell architecture including an S1 GW according to an embodiment of the present invention.

Referring to FIG. 20, the S1 GW is deployed between LTE small cell eNBs and MME when a UMTS macro cell, served by the Node B, and LTE small cells, served by the LTE small cell eNBs, coexist. The S1 GW is deployed for hotspots which boost up capacity within coverage of the UMTS macro cell. Each LTE small cell eNB is connected with the S1 GW via the S1 interface or a newly defined interface. The S1 GW is connected with the MME via the S1 interface or a newly defined interface. The LTE small cell eNBs may regard the S1 GW as the MME. The MME may regard the S1 GW as the eNB or the S1 GW, which is a new entity. The S1 GW may reduce signaling overhead of the MME by replacing S1 interfaces between the MME and LTE small cell eNBs.

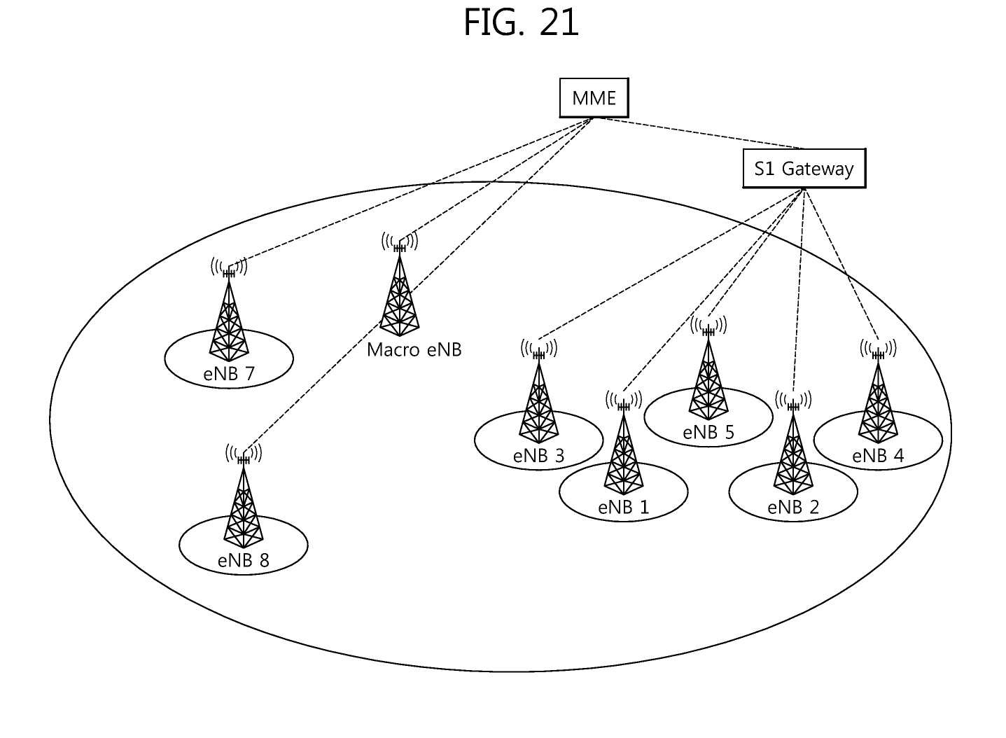

FIG. 21 shows an example of small cell architecture including an S1 GW according to another embodiment of the present invention.

Referring to FIG. 21, the S1 GW is deployed between LTE small cell eNBs and MME when a LTE macro cell, served by the macro eNB, and LTE small cells, served by the LTE small cell eNBs, coexist. The S1 GW is deployed for hotspots which boost up capacity within coverage of the LTE macro cell. Each LTE small cell eNB is connected with the S1 GW via the S1 interface or a newly defined interface. The S1 GW is connected with the MME via the S1 interface or a newly defined interface. The LTE small cell eNBs may regard the S1 GW as the MME. The MME may regard the S1 GW as the eNB or the S1 GW, which is a new entity. The S1 GW may reduce signaling overhead of the MME by replacing S1 interfaces between the MME and LTE small cell eNBs.

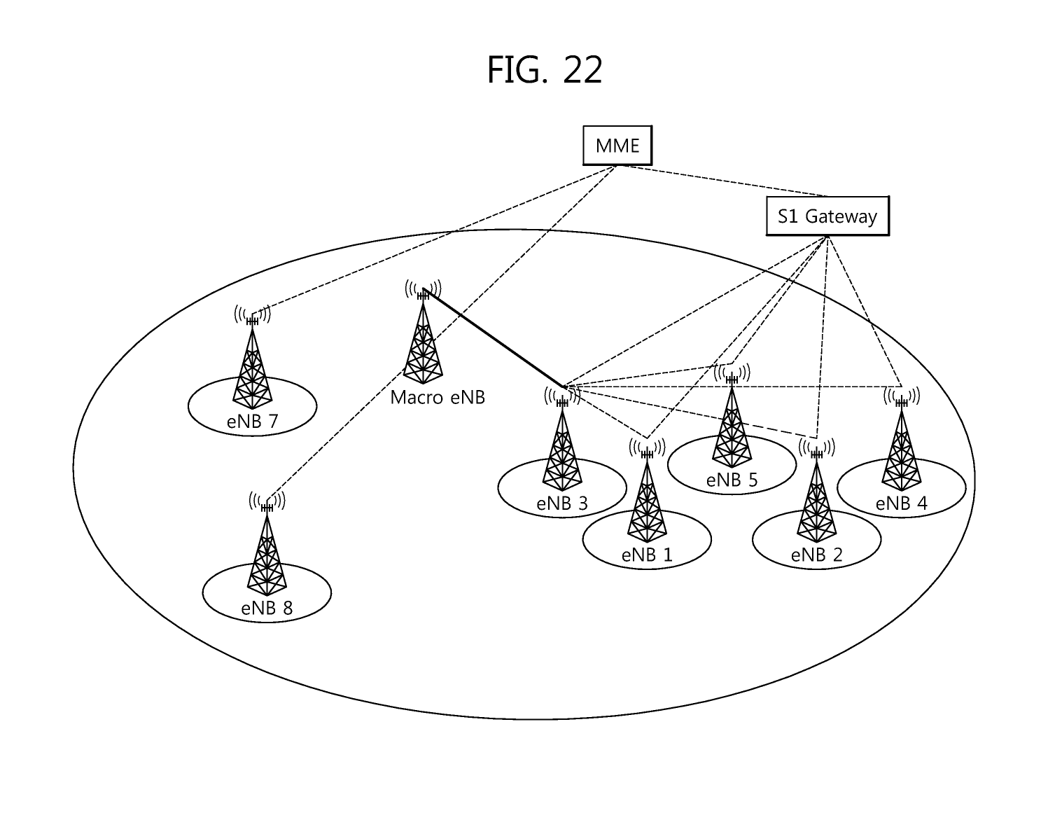

FIG. 22 shows an example of small cell architecture including an S1 GW according to another embodiment of the present invention.

Referring to FIG. 22, the S1 GW is deployed between LTE small cell eNBs and MME when a LTE macro cell, served by the macro eNB, and LTE small cells, served by the LTE small cell eNBs, coexist. The S1 GW is deployed for hotspots which boost up capacity within coverage of the LTE macro cell. Each LTE small cell eNB is connected with the S1 GW via the S1 interface or a newly defined interface. The S1 GW is connected with the MME via the S1 interface or a newly defined interface. The LTE small cell eNBs may regard the S1 GW as the MME. The MME may regard the S1 GW as the eNB or the S1 GW, which is a new entity. The S1 GW may reduce signaling overhead of the MME by replacing S1 interfaces between the MME and LTE small cell eNBs.

In addition, one LTE small cell eNB may be configured as a CH. That is, the S1 GW and CH may coexist. In FIG. 22, eNB3 is configured as the CH. The CH is connected with the macro eNB via the X2 interface or a newly defined interface.

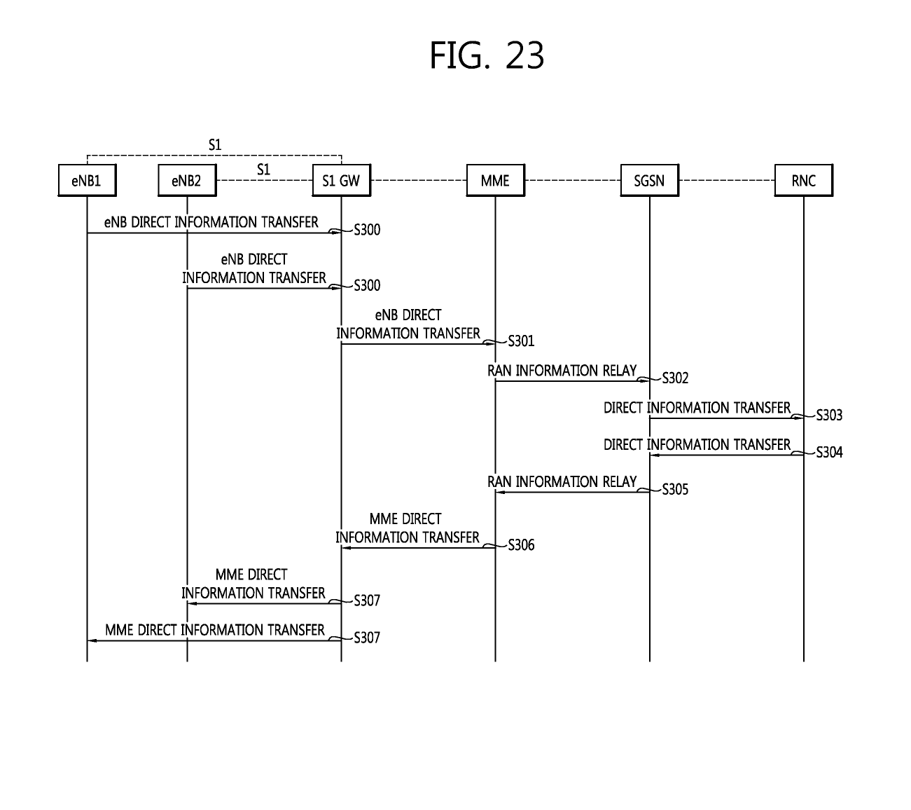

FIG. 23 shows an example of method for transmitting cell load information using an S1 GW according to an embodiment of the present invention. In this embodiment, the LTE small cell eNB requests cell load information from the RNC using the S1 GW. It is assumed that the LTE small cell eNB is connected with the S1 GW via the S1 interface. The LTE small cell eNB may regard the S1 GW as the MME, and the MME may regard the S1 GW as the eNB.

In step S300, the eNB1 and eNB2, located in a cluster of LTE small cells, transmit eNB direct information transfer messages, including a request for cell load information, to the S1 GW via the S1 interface, respectively. The eNB direct information transfer message may include a self-optimization network (SON) transfer request container including the request for the cell load information.

In step S301, the S1 GW delivers the eNB direct information transfer message to the MME via the S1 interface or a newly defined interface. Only one eNB direct information transfer message may be transmitted by concatenating multiple base station system (BSS) containers for requests from multiple LTE small cells.

In step S302, the MME transmits the RAN information relay message to the SGSN. In step S303, the SGSN transmits the direct information transfer message to the RNC. Accordingly, the requests for the cell load information from the eNB1 and eNB2 are delivered to the RNC.

In step S304, the RNC transmits the direct information transfer message, including cell load information of cells managed by the RNC, to the SGSN. In the direct information transfer message, multiple SON transfer response containers may be concatenated. In step S305, the SGSN transmits the RAN information relay message, including the cell load information of cells managed by the RNC, to the MME. In the RAN information relay message, multiple SON transfer response containers may be concatenated.

In step S306, the MME transmits the MME direct information transfer message, including the cell load information of cells managed by the RNC, to the S1 GW via the S1 interface or a newly defined interface. In the MME direct information transfer message, multiple SON transfer response containers may be concatenated.

In step S307, the S1 GW delivers the MME direct information transfer messages, including the cell load information of cells managed by the RNC, to the eNB1 and eNB2 via the S1 interface, respectively. Accordingly, requested cell load information is delivered to each eNB.

In this embodiment, conventional RAN information management (RIM) procedure is used for transmitting cell load information. However, the present invention is not limited thereto, and if the conventional RIM procedure is not used, messages including information corresponding to the SON transfer request container or SON transfer response container may be newly defined in each interface.

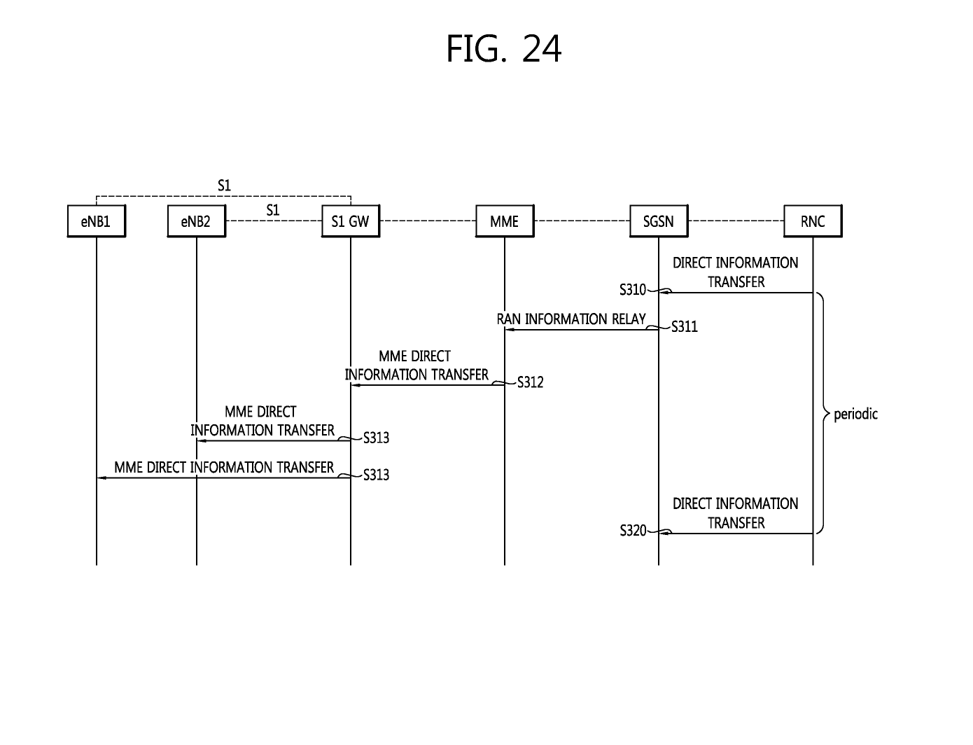

FIG. 24 shows an example of method for transmitting cell load information using an S1 GW according to another embodiment of the present invention. In this embodiment, the RNC reports cell load information to the LTE small cell eNB using the S1 GW in a periodic manner. It is assumed that the LTE small cell eNB is connected with the S1 GW via the 51 interface. The LTE small cell eNB may regard the S1 GW as the MME, and the MME may regard the S1 GW as the eNB.

In step S310, the RNC transmits the direct information transfer message, including cell load information and target cell IDs, to the SGSN. In step S311, the SGSN transmits the RAN information relay message, including the cell load information and target cell IDs, to the MME. In step S312, the MME transmits the MME direct information transfer message, including the cell load information and target cell IDs, to the S1 GW via the S1 interface or a newly defined interface.

In step S313, the S1 GW transmits the MME direct information transfer messages, including the cell load information and corresponding target cell ID, to the eNB1 and eNB2 via the S1 interface, respectively. Accordingly, the eNBs obtains cell load information of cells managed by the RNC.

In step S320, in a next period, the RNC transmits again the direct information transfer message to the SGSN.

In this embodiment, conventional RIM procedure is used for transmitting cell load information. However, the present invention is not limited thereto, and instead of the conventional RIM procedure, new messages may be defined for transmitting cell load information.

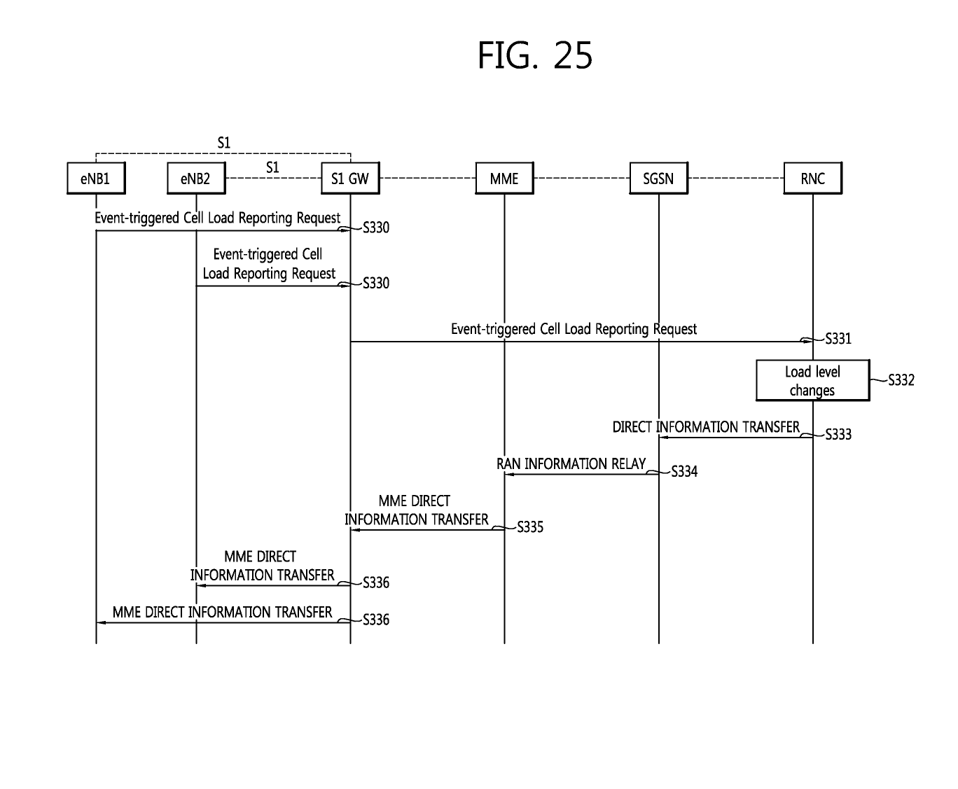

FIG. 25 shows an example of method for transmitting cell load information using an S1 GW according to another embodiment of the present invention. In this embodiment, the RNC reports cell load information to the LTE small cell eNB using the S1 GW in an event-triggered manner. It is assumed that the LTE small cell eNB is connected with the S1 GW via the S1 interface. The LTE small cell eNB may regard the S1 GW as the MME, and the MME may regard the S1 GW as the eNB.

In step S330, the eNB1 and eNB2 transmit the event-triggered cell load reporting request messages to the S1 GW via the S1 interface, respectively. In step S331, the S1 GW delivers the event-triggered cell load reporting request message to the RNC by concatenating the event-triggered cell load reporting request messages from the eNB1 and eNB2.

In step S332, load level of the RNC changes. Accordingly, load level of the RNC may exceed a threshold. The threshold may be pre-determined In step S333, the RNC transmits the direct information transfer message, including cell load information, to the SGSN. In step S334, the SGSN transmits the RAN information relay message, including the cell load information, to the MME. In step S335, the MME transmits the MME direct information transfer message, including the event-triggered cell load reporting response message and the cell load information, to the S1 GW via the S1 interface or a newly defined interface.

In step S336, the S1 GW transmits the MME direct information messages, including the cell load information, to the eNB1 and eNB2 via the S1 interface, respectively. Accordingly, the eNB1 obtains cell load information of cells managed by the RNC.

In this embodiment, conventional RIM procedure is used for transmitting cell load information. However, the present invention is not limited thereto, and instead of the conventional RIM procedure, new messages may be defined for transmitting cell load information.

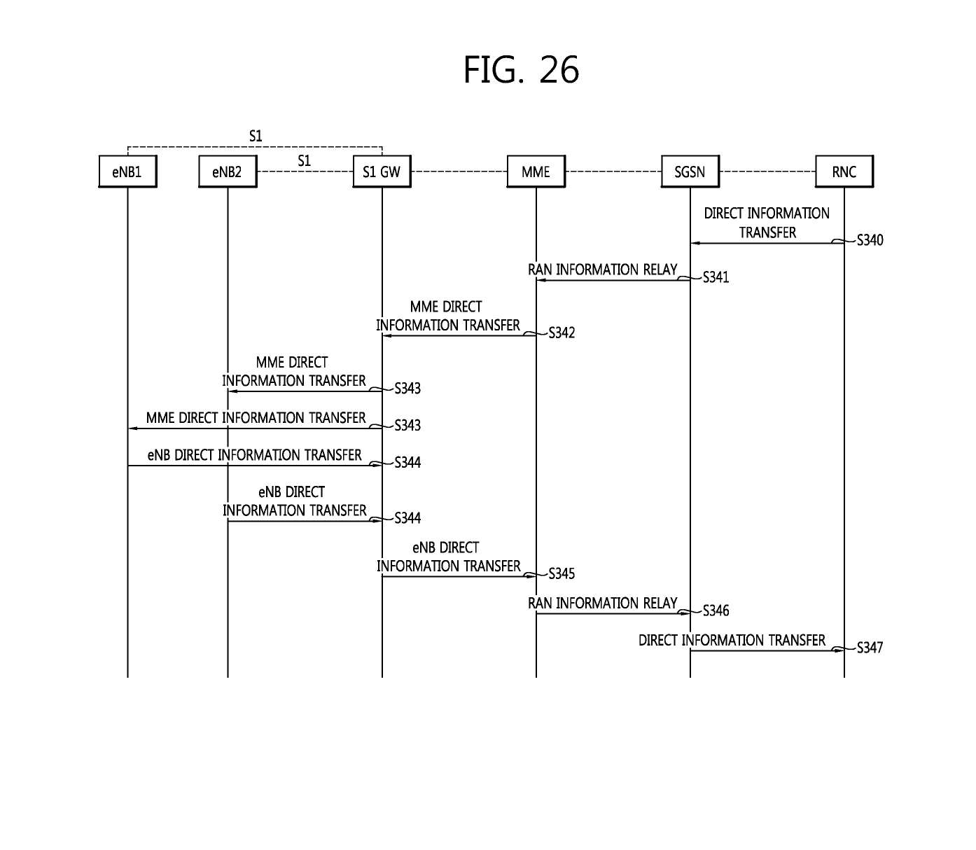

FIG. 26 shows an example of method for transmitting cell load information using an S1 GW according to another embodiment of the present invention. In this embodiment, the RNC requests cell load information from the LTE small cell eNB using the S1 GW. It is assumed that the LTE small cell eNB is connected with the S1 GW via the S1 interface. The LTE small cell eNB may regard the S1 GW as the MME, and the MME may regard the S1 GW as the eNB.

In step S340, the RNC transmits the direct information transfer message, including a request for cell load information and target cell IDs, to the SGSN. In step S341, the SGSN transmits the RAN information relay message, including the request for the cell load information and target cell IDs, to the MME. In step S342, the MME transmits the MME direct information transfer message, including the request for the cell load information and target cell IDs, to the S1 GW via the S1 interface or a newly defined interface. The request for the cell load information included in the MME direct information transfer message may include multiple requests for cell load information of multiple LTE small cells.

In step S343, the S1 GW transmits the MME direct information transfer messages, including the request for the cell load information and corresponding target cell ID, to the eNB1 and eNB2 via the S1 interface, respectively. In step S344, the eNB1 and eNB2 transmit the eNB direct information transfer messages, including the cell load information of each LTE small cell, to the S1 GW via the S1 interface, respectively.

In step S345, the S1 GW transmits the eNB direct information transfer message, including the cell load information, to the MME via the S1 interface or a newly defined interface. The cell load information may include concatenated cell load information of each LTE small cells. In step S346, the MME transmits the RAN information relay message, including the cell load information, to the SGSN. In step S347, the SGSN transmits the direct information transfer message, including the cell load information, to the RNC. Accordingly, the RNC obtains cell load information of LTE small cells.

In this embodiment, conventional RIM procedure is used for transmitting cell load information. However, the present invention is not limited thereto, and instead of the conventional RIM procedure, new messages may be defined for transmitting cell load information.

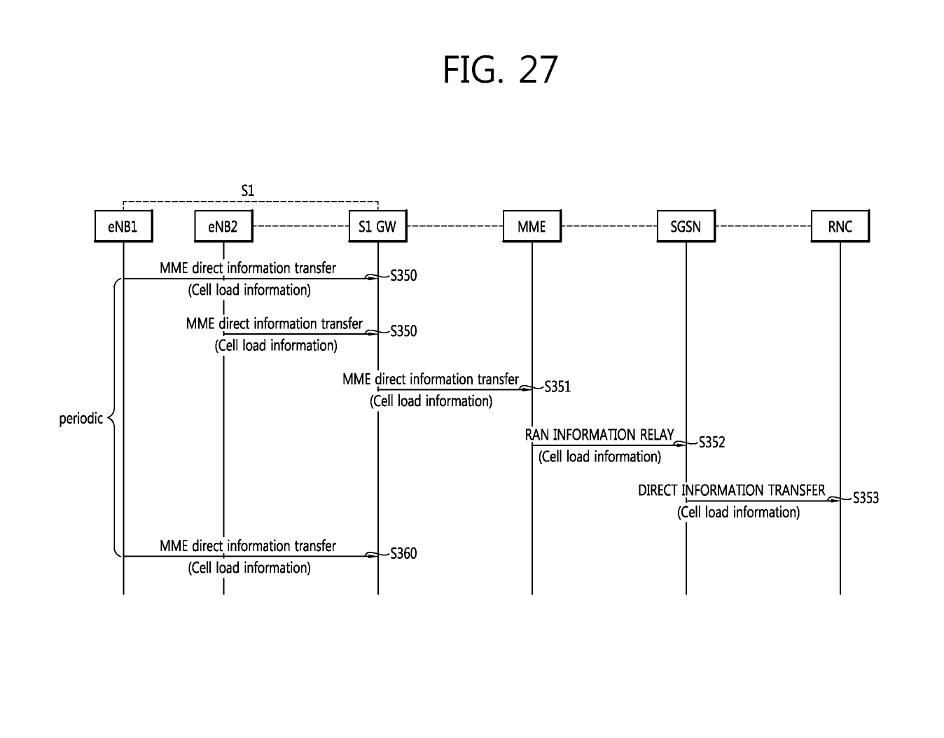

FIG. 27 shows an example of method for transmitting cell load information using an S1 GW according to another embodiment of the present invention. In this embodiment, the LTE small cell eNB reports cell load information to the RNC using the S1 GW in a periodic manner. It is assumed that the LTE small cell eNB is connected with the S1 GW via the S1 interface. The LTE small cell eNB may regard the S1 GW as the MME, and the MME may regard the S1 GW as the eNB.

In step S350, the eNB1 and eNB2 transmit the MME direct information transfer message, including cell load information of each LTE small cell, to the S1 GW via the S1 interface, respectively. In step S351, the S1 GW transmits the MME direct information transfer message, including the cell load information, to the MME via the S1 interface or a newly defined interface.

In step S352, the MME transmits the RAN information relay message, including the cell load information, to the SGSN. In step S353, the SGSN transmits the direct information transfer message, including the cell load information, to the RNC. Accordingly, the RNC obtains cell load information of LTE small cells.

In step S360, in a next period, the eNB1 transmits again the MME direct information transfer message, including cell load information, to the S1 GW via the S1 interface.

In this embodiment, conventional RIM procedure is used for transmitting cell load information. However, the present invention is not limited thereto, and instead of the conventional RIM procedure, new messages may be defined for transmitting cell load information.

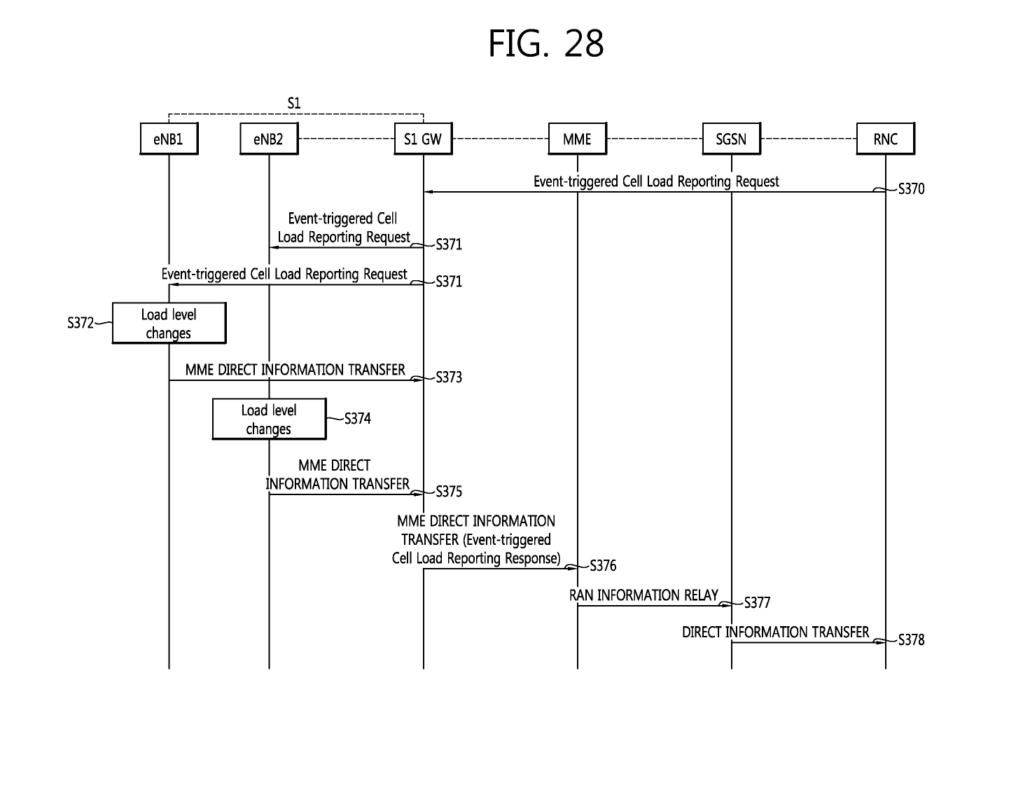

FIG. 28 shows an example of method for transmitting cell load information using an S1 GW according to another embodiment of the present invention. In this embodiment, the LTE small cell eNB reports cell load information to the RNC using the S1 GW in an event-triggered manner. It is assumed that the LTE small cell eNB is connected with the S1 GW via the S1 interface. The LTE small cell eNB may regard the S1 GW as the MME, and the MME may regard the S1 GW as the eNB.

In step S370, the RNC transmits the event-triggered cell load reporting request message to the S1 GW. In step S371, the S1 GW delivers the event-triggered cell load reporting request message to the eNB1 and eNB2 via the S1 interface, respectively.

In step S372, load level of the eNB1 changes. Accordingly, load level of the eNB1 may exceed a threshold. The threshold may be pre-determined In step S373, the eNB1 transmits the MME direct information transfer message, including the cell load information, to the S1 GW via the S1 interface.

In step S374, load level of the eNB2 changes. Accordingly, load level of the eNB2 may exceed a threshold. The threshold may be pre-determined In step S375, the eNB2 transmits the MME direct information transfer message, including the cell load information, to the S1 GW via the Si interface.

In step S376, the S1 GW transmits the MME direct information transfer message, including the event-triggered cell load reporting response message and the cell load information received from the eNB1 and eNB2, to the MME via the Si interface or a newly defined interface. The cell load information received from the eNB1 and eNB2 may be concatenated. In step S377, the MME transmits the RAN information relay message, including the cell load information, to the SGSN. In step S378, the SGSN transmits the direct information transfer message, including the cell load information, to the RNC. Accordingly, the RNC obtains cell load information of LTE small cells.

In this embodiment, conventional RIM procedure is used for transmitting cell load information. However, the present invention is not limited thereto, and instead of the conventional RIM procedure, new messages may be defined for transmitting cell load information.

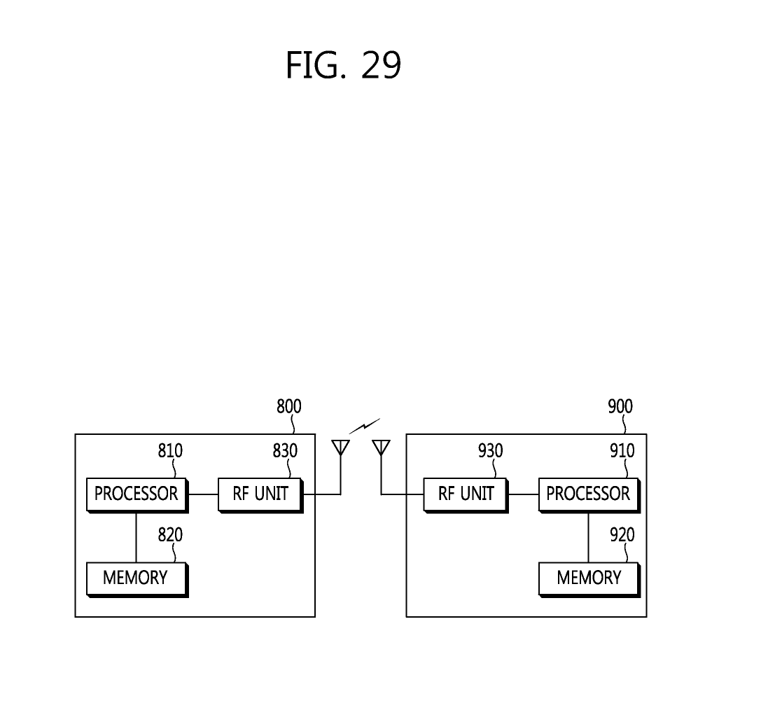

FIG. 29 shows a wireless communication system to implement an embodiment of the present invention.

An eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An eNB or S1 GW or RNC 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for transmitting, by an eNodeB (eNB) of a first system, cell load information in a wireless communication system, the method comprising:
transmitting cell load information of a cell, managed by the eNB, to a radio network controller (RNC) of a second system via a direct path between the eNB and the RNC.

2. The method of claim 1, wherein the cell load information is transmitted in a periodic manner or an event-triggered manner.

3. The method of claim 1, wherein the cell load information is transmitted after receiving a request for the cell load information from the RNC of the second system via the direct path.

4. The method of claim 1, wherein the cell load information includes cell load information of cells managed by a plurality of eNBs in a cluster, where the plurality of eNBs are deployed densely.

5. The method of claim 4, wherein the cell load information of cells managed by the plurality of eNBs is received in a periodic manner or an event-triggered manner.

6. The method of claim 4, wherein the cell load information of cells managed by the plurality of eNBs is received via a resource status response message or a resource status update message.

7. A method for transmitting, by a radio network controller (RNC) of a second system, cell load information in a wireless communication system, the method comprising:
transmitting cell load information of a cell, managed by the RNC, to an eNodeB (eNB) of a first system via a direct path between the eNB and the RNC.

8. The method of claim 7, wherein the cell load information is transmitted in a periodic manner or an event-triggered manner.

9. The method of claim 7, wherein the cell load information is transmitted after receiving a request for the cell load information from the eNB of the first system via the direct path.

10. The method of claim 7, wherein the cell load information is transmitted to the eNB of the first system through a cluster head which is a representative eNB of a cluster where a plurality of eNBs are deployed densely.

11. A method for transmitting, by a S1 gateway (GW), cell load information in a wireless communication system, the method comprising:
receiving cell load information of a cell, managed by a radio network controller (RNC) of the second system, from the RNC; and
transmitting the received cell load information to a plurality of eNodeBs (eNBs) of the first system, respectively.

12. The method of claim 11, wherein the cell load information is received using a mobility management entity (MME) direct information transfer message via an S1 interface, and
wherein the cell load information is received from the RNC via an MME and a serving GPRS support node (SGSN).

13. The method of claim 11, wherein the received cell load information is transmitted using an MME direct information transfer message.

14. The method of claim 11, wherein the cell load information is received in a periodic manner or an event-triggered manner.

15. The method of claim 11, further comprising:
receiving cell load information requests from the plurality of eNBs of the first system.
